(19) United States
(12) Patent Application Publication
(10) Pub. No.: US 2023/0264777 A1
(43) Pub. Date: Aug. 24, 2023

(54) IMPACT FILM FOR BICYCLES

(71) Applicant: Trek Bicycle Corporation, Waterloo, WI (US)

(72) Inventors: Erik Beckman, Madison, WI (US); Matt Yerke, Madison, WI (US)

(21) Appl. No.: 17/651,935

(22) Filed: Feb. 22, 2022

(51) Int. Cl. B62K 19/16; B62K 19/34; B29C 70/30

(52) U.S. Cl. CPC B62K 19/16; B62K 19/34; B29C 70/30; B29L 2031/3091

(57) ABSTRACT

A method of making a bicycle frame includes placing an impact resistant film into one or more portions of a bicycle frame mold. The method also includes placing a plurality of layers of carbon fiber into the bicycle frame mold. The method further includes applying heat to the bicycle frame mold to form a bicycle frame that has an exterior surface, wherein at least a portion of the exterior surface is covered by the impact resistant film.

### BACKGROUND

Bicycles are used on a variety of different terrain types, including roads, concrete trails, dirt/woods trails, mountain trails, beaches, etc. These various terrain types can expose a bicycle to impact with rocks, trees, and other objects. Such impacts can result in damage to the bicycle frame in the form of chipped or cracked paint, cracks or holes in the bicycle tubes, etc. In addition to affecting the aesthetics of the bicycle, such damage can also potentially compromise the structural integrity of the bicycle frame.

### SUMMARY

An illustrative method of making a bicycle frame includes placing an impact resistant film into one or more portions of a bicycle frame mold. The method also includes placing a plurality of layers of carbon fiber into the bicycle frame mold. The method further includes applying heat to the bicycle frame mold to form a bicycle frame that has an exterior surface, wherein at least a portion of the exterior surface is covered by the impact resistant film. In some embodiments, the method also includes applying a layer of paint to the bicycle frame such that the layer of paint covers the impact resistant film.

In one embodiment, the impact resistant film comprises a thermoplastic polyurethane (TPU). In another embodiment, the impact resistant film has a thickness between 0.25 millimeters (mm) and 0.5 mm. In some embodiments, the one or more portions of the bicycle mold include a portion of the bicycle mold that forms a bottom of a down tube of the bicycle frame. The one or more portions of the bicycle mold can also include a portion of the bicycle mold that forms a top of chain stays of the bicycle frame. The one or more portions of the bicycle mold can further include a portion of the bicycle mold that forms a bottom of a bottom bracket of the bicycle frame. The one or more portions of the bicycle mold can also include a portion of the bicycle mold that forms a front portion of front forks of the bicycle frame. In another embodiment, the one or more portions of the bicycle frame comprise an entire bicycle frame. In an illustrative embodiment, the bicycle frame is a laminate, and applying the heat incorporates the impact resistant film as an integral layer of the laminate.

An illustrative bicycle frame includes a top tube connected to a steerer tube and seat stays. The bicycle frame also includes a down tube connected to the steerer tube and to a bottom bracket. The bicycle frame also includes chain stays connected to the bottom bracket. The bicycle frame further includes an impact resistant film applied to one or more portions of the down tube. In some embodiments, a layer of paint is applied to the bicycle frame such that the layer of paint covers the impact resistant film.

In an illustrative embodiment, the impact resistant film is a thermoplastic polyurethane (TPU). In one embodiment, the impact resistant film has a thickness between 0.25 millimeters (mm) and 0.5 mm. In some embodiments, the one or more portions of the down tube include a bottom portion of the down tube. In another embodiment, the impact resistant film comprises a first impact resistant film, and a second impact resistant film is applied to a top portion of the chain stays of the bicycle frame. In another embodiment, the impact resistant film comprises a first impact resistant film, and a second impact resistant film is applied to a bottom of the bottom bracket of the bicycle frame. In yet another embodiment, the impact resistant film comprises a first impact resistant film, and a second impact resistant film is applied to a front portion of front forks of the bicycle frame. In an alternative embodiment, the impact resistant layer is applied to the top tube, the steerer tube, the seat stays, the down tube, the bottom bracket, and the chain stays. In an illustrative embodiment, the bicycle frame is a laminate, and the impact resistant film is formed with the bicycle frame as an integral layer of the laminate.

Other principal features and advantages of the invention will become apparent to those skilled in the art upon review of the following drawings, the detailed description, and the appended claims.

### BRIEF DESCRIPTION OF THE DRAWINGS

Illustrative embodiments will hereafter be described with reference to the accompanying drawings, wherein like numerals denote like elements. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 shows a bicycle that has a bicycle frame with an impact resistant film applied thereto in accordance with an illustrative embodiment.

FIG. 2 depicts an impact resistant film applied to a portion of a raw carbon bicycle frame in accordance with an illustrative embodiment.

FIG. 3 is cross-sectioned microscope image of a downtube that shows the location of an impact resistant film in accordance with an illustrative embodiment.

FIG. 4A is a side view of a bicycle frame in which a bottom of a down tube includes an impact resistant film in accordance with an illustrative embodiment.

FIG. 4B is a bottom view of the bicycle frame in which the bottom of the down tube includes the impact resistant film in accordance with an illustrative embodiment.

FIG. 4C is a bottom perspective view of the bicycle frame in which the bottom of the down tube includes the impact resistant film in accordance with an illustrative embodiment.

FIG. 4D is a perspective view of an impact resistant film applied to a top portion of chain stays in accordance with an illustrative embodiment.

FIG. 5 is a flow diagram depicting operations to apply an impact resistant film to a bicycle frame in accordance with an illustrative embodiment.

### DETAILED DESCRIPTION

The down tubes and other portions of a bicycle frame are susceptible to impacts from debris flung up by the front tire, debris flung from other vehicles, trail obstacles, etc. This debris can strike the frame with significant energy, and sometimes with enough energy to crack or otherwise damage the frame. Described herein is an impact resistant film that can be added to a bicycle frame to improve impact strength. Adding this layer of protection allows bicycles to be more durable, which results in longer product life, fewer warranty/replacement claims, and a better customer experience.

In an illustrative embodiment, the bicycle frame can be a carbon frame, and the impact resistant film can be added to the carbon bicycle frame laminate. While many of the embodiments herein describe such a carbon fiber bicycle frame, it is to be understood that in alternative embodiments the bicycle frame may be made from other materials such as aluminum, titanium, steel, etc. The impact resistant film acts as a damper that prevent cracks from developing and/or propagating in the bicycle frame. Specifically, the impact resistant film disperses impact energy across a larger surface area than the frame itself (e.g., carbon fiber) can. This improves impact resistance by avoiding localized fiber failure. The impact resistant film provides unique benefits that cannot be achieved by simply adding more layers of carbon fiber to the laminate.

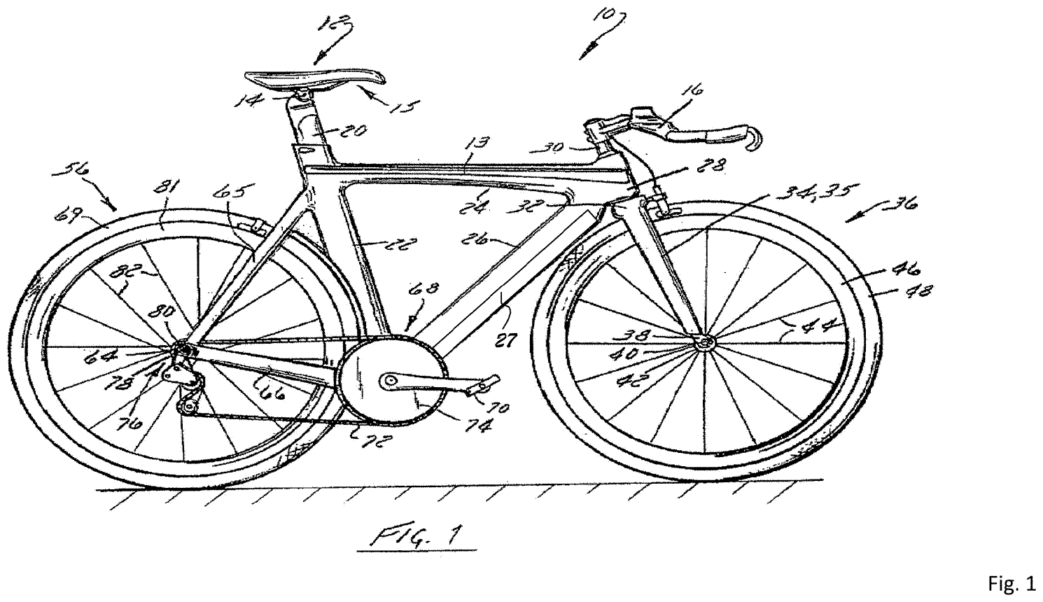

FIG. 1 shows a bicycle 10 that has a bicycle frame 13 with an impact resistant film 27 applied thereto in accordance with an illustrative embodiment. As shown, the impact resistant film 27 is applied to a bottom portion of a down tube 26 of the bicycle frame. In alternative embodiments, the impact resistant film can be applied to the entire down tube 26 and/or on different components of the bicycle 10. Mounted to the bicycle frame 13 are a seat assembly 12 and handlebars 16. A seat clamp 14 is engaged with an underside 15 of seat assembly 12 and cooperates with a seat post 20 that slidably engages a seat tube 22 of frame 13. A top tube 24 and the down tube 26 extend forwardly from seat tube 22 to a head tube 28 of bicycle frame 13. In alternative embodiments, the impact resistant film 27 can be included on one or more portions of the top tube 24, one or more portions of the seat tube 22, one or more portions of the head tube 28, etc.

Handlebars 16 are connected to a steerer tube 30 that passes through head tube 28 and engages a fork crown 32. A pair of forks 34, 35 extend from generally opposite ends of fork crown 32 and are constructed to support a front wheel assembly 36 at an end thereof or fork tip 38. Fork tips 38 engage generally opposite sides of an axle 40 that is constructed to engage a hub 42 of front wheel assembly 36. A number of spokes 44 extend from hub 42 to a rim 46 of front wheel assembly 36. A tire 48 is engaged with rim 46 such that rotation of tire 48, relative to forks 34, rotates rim 46 and hub 42.

A rear wheel assembly 56 is positioned generally concentrically about a rear axle 64. A seat stay 65 and a chain stay 66 offset rear axle 64 from a crankset 68. Crankset 68 includes pedals 70 that are operationally connected to a flexible drive such as a chain 72 via a chain ring or sprocket 74. Rotation of chain 72 communicates a drive force to a rear section 76 of bicycle 10 having a gear cluster 78 positioned thereat. Gear cluster 78 is generally concentrically orientated with respect to rear axle 64 and includes a number of variable diameter gears. In some embodiments, the impact resistant film 27 can be applied to one or more portions of the seat stay 65, one or more portions of the chain stay 66, one or more portions of the crankset 68, etc.

Gear cluster 78 is operationally connected to a hub 80 associated with a rear tire 69 of rear wheel assembly 56. A number of spokes 82 extend radially between hub 80 and a rim 81 that supports tire 69 of rear wheel assembly 56. As is commonly understood, rider operation of pedals 70 drives chain 72 thereby driving rear tire 69 which in turn propels bicycle 10. It is to be understood that bicycle 10 could be provided in either of a road bicycle, mountain bicycle, off-road bicycle, trail bicycle, etc. configuration. It is also to be understood that each configuration includes features generally directed to the intended operating environment of the bicycle. For example, trail bicycles generally include more robust suspension and tire systems than road bicycles.

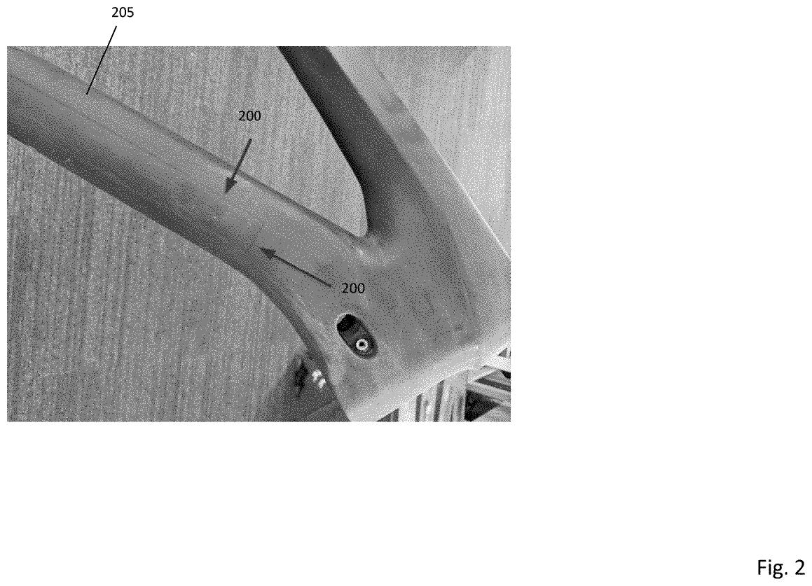

In an illustrative embodiment, when producing a carbon frame, the impact resistant layer can be applied such that it sits on an outermost layer of the mold. As a result, the impact resistant layer is molded permanently into the frame with the other sheets of carbon fiber. The impact resistant film is therefore able to provide a protective barrier to the carbon fiber underneath. FIG. 2 depicts an impact resistant film 200 applied to a portion of a raw carbon bicycle frame 205 in accordance with an illustrative embodiment. Specifically, the impact resistant film 200 is applied to a bottom portion of the down tube of the bicycle frame 205 to help protect the down tube. In alternative embodiments, the impact resistant film 200 may be applied to the entire down tube and/or to other portions of the bicycle frame 205. As shown in FIG. 2, a perimeter of the impact resistant film 200 is visible and distinguished by a silhouette.

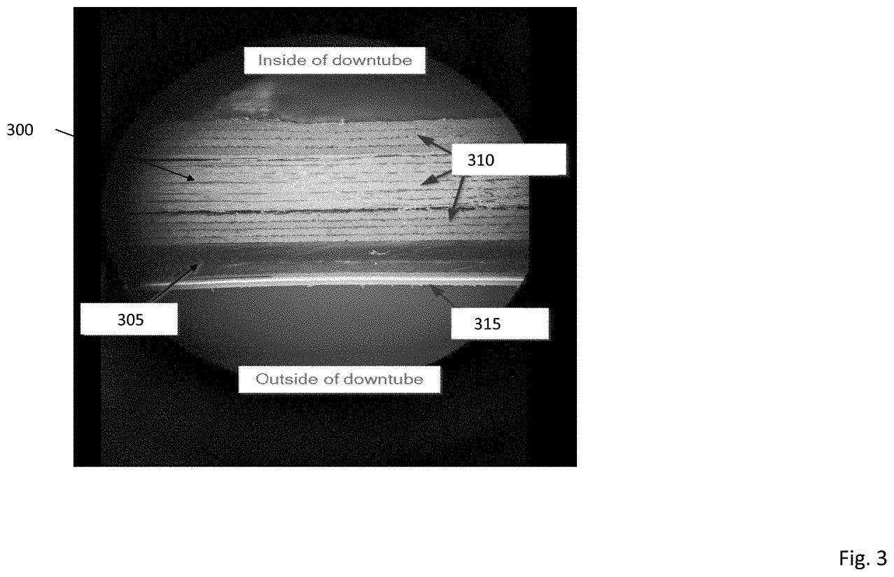

As discussed above, during formation of a carbon fiber bicycle frame, the impact resistant film can be added as an exterior layer of material in the laminate. As a result, application of the impact resistant film does not require special molds or tooling, and the film can be added to frames being produced on existing molds. FIG. 3 is cross-sectioned microscope image of a down tube 300 that shows the location of an impact resistant film 305 in accordance with an illustrative embodiment. As shown, the impact resistant film 305 layer is the outermost layer of the laminate in the down tube 300. Also shown are layers of carbon plys 310 that form the down tube 300, and a paint layer 315 that is applied to the down tube 300. In an illustrative embodiment, the paint layer 315 is applied over the top of the impact resistant film 305.

In one embodiment, the impact resistant film can be formed from a thermoplastic polyurethane (TPU). In some embodiment, the TPU can have a proportion of 1.23, a hardness of 60 (Shore D), a tensile strength of 659 kilograms/square centimeter (kg/cm²) (warp) and 643 kg/cm² (weft), a 300% modulus of 479 kg/cm² (warp) and 453 kg/cm² (weft), an elongation of 380% (warp) and 394% (weft), a crack strength of 185 kg/cm (warp) and 178 kg/cm (weft), and a melting point of 180° Celsius. In alternative embodiments, different values may be used for the various TPU characteristics. Additionally, in other alternative embodiments, the impact resistant film can be made from other materials such as polypropylene, acrylonitrile butadiene styrene, polycarbonate, other thermoplastics, and/or combinations of these materials.

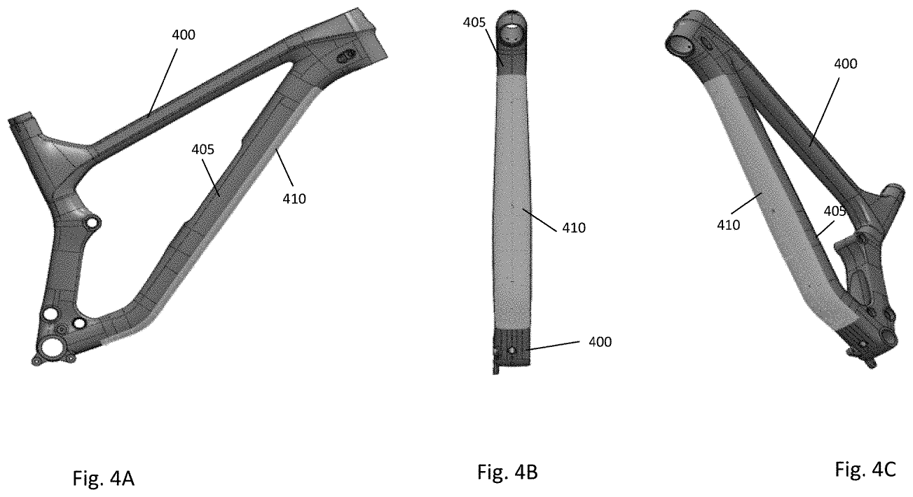

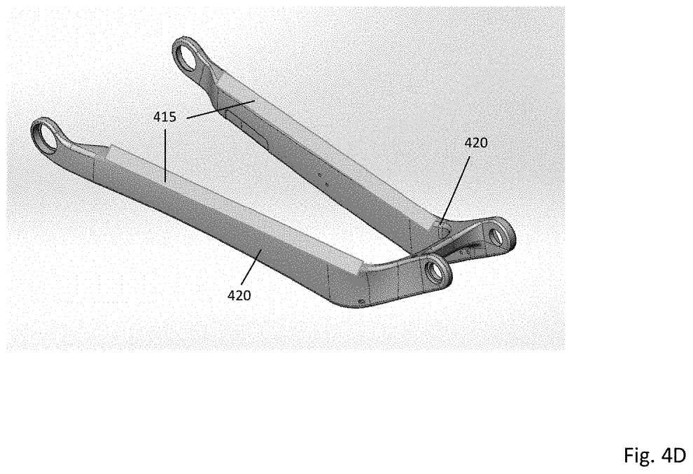

In an illustrative embodiment, the impact resistant film is applied only to high-impact zones of the bicycle frame. The impact resistant film can be applied to mountain bike frames, road bike frames, city bike frames, or any other type of bicycle frame. FIG. 4 depicts application of an impact resistant film to high-impact zones of a bicycle frame. Specifically, FIG. 4A is a side view of a bicycle frame 400 in which a bottom of a down tube 405 includes an impact resistant film 410 in accordance with an illustrative embodiment. FIG. 4B is a bottom view of the bicycle frame 400 in which the bottom of the down tube 405 includes the impact resistant film 410 in accordance with an illustrative embodiment. FIG. 4C is a bottom perspective view of the bicycle frame 400 in which the bottom of the down tube 405 includes the impact resistant film 410 in accordance with an illustrative embodiment. FIG. 4D is a perspective view of an impact resistant film 415 applied to a top portion of chain stays 420 in accordance with an illustrative embodiment. As shown, the impact resistant film 415 is applied to a top portion of chain stays 420 to help protect the chain stays 420 from impact with the chain and other objects.

The embodiments of FIG. 4 are meant only as examples, and it is to be understood that the impact resistant film can be applied to additional areas of the bicycle, including the entire bicycle frame. As other examples, the impact resistant film can be applied to a top portion, bottom portion, and/or side portions of the down tube, the top tube, the chain stays, the seat stays, the bottom bracket, the bicycle forks, the crown, the seat tube, the steerer tube, etc.

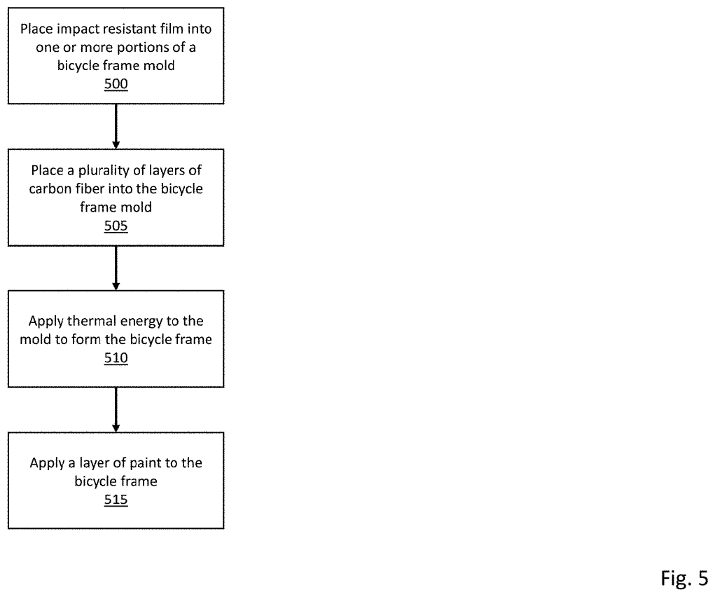

FIG. 5 is a flow diagram depicting operations to apply an impact resistant film to a bicycle frame in accordance with an illustrative embodiment. In alternative embodiments, fewer, additional, and/or different operations may be performed. Also, the use of a flow diagram is not meant to be limiting with respect to the order of operations performed. In an operation 500, an impact resistant film is placed into one or more portions of a bicycle frame mold. Any type of mold can be used. In an illustrative embodiment, the impact resistant film is a TPU. In alternative embodiments, a different type of impact resistant film may be used. The bicycle frame mold can refer to one or more molds that are used to mold the down tube, top tube, chain stays, seat stays, crown, front forks, seat tube, bottom bracket, etc. of the bicycle, and is not limited to the front triangle of the bicycle frame. In one embodiment, a thickness of the impact resistant film can be 0.4 millimeters (mm). Alternatively, different thicknesses may be used, such as 0.25 mm, 0.3 mm, 0.5 mm, etc.

In another illustrative embodiment, the impact resistant film is applied only to high impact areas of the bicycle frame, which can include a bottom portion of the down tube, a top and/or bottom portion of the chain stays, a top and/or bottom portion of the seat stays, a front portion of the forks, the crown, etc. As other examples, the impact resistant film can be applied to a top portion, bottom portion, and/or side portions of the down tube, the top tube, the chain stays, the seat stays, the bottom bracket, the bicycle forks, the crown, the seat tube, the steerer tube, etc. In another embodiment, the impact resistant film can be applied to the entire bicycle frame.

In an operation 505, a plurality of layers of carbon fiber are placed into the bicycle frame mold. The layers of carbon fiber can be formed and placed into the mold using any techniques known in the art. In an operation 510, thermal energy (i.e., heat) is applied to the bicycle frame mold to form the bicycle frame. A result of the heating is an integral bicycle frame (or bicycle frame component), at least a portion of which includes the impact resistant film as its outer layer. In an operation 515, a layer of paint is applied to the bicycle frame. The paint can be applied over the top of the carbon frame and the impact resistant film applied thereto. Any type of bicycle paint may be used.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more”.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A method of making a bicycle frame comprising:
placing an impact resistant film into one or more portions of a bicycle frame mold;
placing a plurality of layers of carbon fiber into the bicycle frame mold; and
applying heat to the bicycle frame mold to form a bicycle frame that has an exterior surface, wherein at least a portion of the exterior surface is covered by the impact resistant film.

2. The method of claim 1, further comprising applying a layer of paint to the bicycle frame such that the layer of paint covers the impact resistant film.

3. The method of claim 1, wherein the impact resistant film comprises a thermoplastic polyurethane (TPU).

4. The method of claim 1, wherein the impact resistant film has a thickness between 0.25 millimeters (mm) and 0.5 mm.

5. The method of claim 1, wherein the one or more portions of the bicycle mold include a portion of the bicycle mold that forms a bottom of a down tube of the bicycle frame.

6. The method of claim 1, wherein the one or more portions of the bicycle mold include a portion of the bicycle mold that forms a top of chain stays of the bicycle frame.

7. The method of claim 1, wherein the one or more portions of the bicycle mold include a portion of the bicycle mold that forms a bottom of a bottom bracket of the bicycle frame.

8. The method of claim 1, wherein the one or more portions of the bicycle mold include a portion of the bicycle mold that forms a front portion of front forks of the bicycle frame.

9. The method of claim 1, wherein the bicycle frame is a laminate, and wherein applying the heat incorporates the impact resistant film as an integral layer of the laminate.

10. The method of claim 1, wherein the one or more portions of the bicycle frame comprise an entire bicycle frame.

11. A bicycle frame comprising:
a top tube connected to a steerer tube and seat stays;
a down tube connected to the steerer tube and to a bottom bracket;
chain stays connected to the bottom bracket; and
an impact resistant film applied to one or more portions of the down tube.

12. The bicycle frame of claim 11, further comprising a layer of paint applied to the bicycle frame such that the layer of paint covers the impact resistant film.

13. The bicycle frame of claim 11, wherein the impact resistant film comprises a thermoplastic polyurethane (TPU).

14. The bicycle frame of claim 11, wherein the impact resistant film has a thickness between 0.25 millimeters (mm) and 0.5 mm.

15. The bicycle frame of claim 11, wherein the one or more portions of the down tube include a bottom portion of the down tube.

16. The bicycle frame of claim 11, wherein the impact resistant film comprises a first impact resistant film, and further comprising a second impact resistant film applied to a top portion of the chain stays of the bicycle frame.

17. The bicycle frame of claim 11, wherein the impact resistant film comprises a first impact resistant film, and further comprising a second impact resistant film applied to a bottom of the bottom bracket of the bicycle frame.

18. The bicycle frame of claim 11, wherein the impact resistant film comprises a first impact resistant film, and further comprising a second impact resistant film applied to a front portion of front forks of the bicycle frame.

19. The bicycle frame of claim 11, wherein the bicycle frame is a laminate, and wherein the impact resistant film is formed with the bicycle frame as an integral layer of the laminate.

20. The bicycle frame of claim 11, wherein the impact resistant layer is applied to the top tube, the steerer tube, the seat stays, the down tube, the bottom bracket, and the chain stays.
